(19) United States
(12) Patent Application Publication
(10) Pub. No.: US 2019/0132555 A1
(43) Pub. Date: May 2, 2019

(54) METHODS AND SYSTEMS TO BROADCAST SENSOR OUTPUTS IN AN AUTOMOTIVE ENVIRONMENT

(71) Applicant: QUALCOMM Incorporated, San Diego, CA (US)

(72) Inventors: Jeffrey Hao Chu, San Diego, CA (US); Rahul Gulati, San Diego, CA (US); Robert Hardacker, Fallbrook, CA (US); Alex Jong, San Diego, CA (US); Mohammad Reza Kakoee, San Diego, CA (US); Behnam Katibian, Irvine, CA (US); Anshuman Saxena, San Diego, CA (US); Sanjay Vishin, Sunnyvale, CA (US); Sanat Kapoor, San Diego, CA (US)

(21) Appl. No.: 16/125,231

(22) Filed: Sep. 7, 2018

Related U.S. Application Data
(60) Provisional application No. 62/578,775, filed on Oct. 30, 2017.

(51) Int. Cl. H04N 7/18; B60R 1/00

(52) U.S. Cl. CPC H04N 7/181; B60R 1/002; B60R 2300/105; B60R 2300/8026; B60R 2300/301; B60R 2300/303; B60R 2300/205

(57) ABSTRACT

Methods and systems to broadcast sensor outputs in an automotive environment allow sensors such as cameras to output relatively unprocessed (raw) data to two or more different processing circuits where the processing circuits are located in separate and distinct embedded control units (ECUs). A first one of the two or more different processing circuits processes the raw data for human consumption. A second one of the two or more different processing circuits processes the raw data for machine utilization such as for autonomous driving functions. Such an arrangement allows for greater flexibility in utilization of the data from the sensors without imposing undue latency in the processing stream and without compromising key performance indices for human use and machine use.

### PRIORITY CLAIM

The present application claims priority to U.S. Provisional Patent Application Ser. No. 62/578,775 filed on Oct. 30, 2017 and entitled “METHODS AND SYSTEMS TO BROADCAST CAMERA OUTPUTS IN AN AUTOMOTIVE ENVIRONMENT,” the contents of which is incorporated herein by reference in its entirety.

### BACKGROUND

### I. Field of the Disclosure

The technology of the disclosure relates generally to using sensors in a vehicle for multiple purposes.

### II. Background

The automotive industry began widespread infiltration into society before the advent of computers. Early computing devices were too large and cumbersome to be practical for incorporation into automobiles. However, as the size and cost of computing devices has come down, vehicles, and automobiles in particular, have embraced the incorporation of computing devices into the regular operation of the vehicles.

While engine management and exhaust control saw the first widespread use of computing devices in automobiles, more recent automobiles have seen a proliferation of computing devices into almost every system with sensors capable of monitoring almost any function related to operation of the vehicle as well as sophisticated audiovisual systems capable of providing robust multimedia experiences for operators and passengers. The proliferation of computing power and computing devices has led to an increase in efforts to assist in the safe operation of such vehicles.

One early effort to assist in the safe operation of a vehicle was the introduction of a backup camera. The operator is able to supplement the view available in the rear view mirror and direct viewing through a rear window with the images from the camera. In many cases so-called blind spots may be eliminated. More recent advances have used cameras to assist in parking cars, and even more recent advances have seen the testing of self-driving or autonomous vehicles. While cameras may be used in each of these activities, there may be different processing requirements for images that are used for human consumption (e.g., the backup camera view) relative to images that are used for machine consumption (e.g., self-parking or self-driving uses). Current approaches to these different processing requirements may use duplicative cameras or may use a single integrated circuit (IC) to perform both processing activities with a shared imaging processing pipe. Other sensors may be used in the self-driving process such as radar, sonar, light detection and ranging (LIDAR), infrared or the like. Likewise, other sensors such as sensors that measure speed, engine revolutions, exhaust, or the like may be used both for self-driving purposes as well as performance calculations. In most cases, where sensors are dual-use, there may duplicative sensors or a single IC performing calculations for both uses. While acceptable, each of these solutions involves compromises. Accordingly, a more optimized solution to these processing requirements is desirable.

### SUMMARY OF THE DISCLOSURE

Aspects disclosed in the detailed description include methods and systems to broadcast sensor outputs in an automotive environment. In particular, sensors such as cameras output relatively unprocessed (raw) data to two or more different processing circuits where the processing circuits are located in separate and distinct embedded control units (ECUs). A first one of the two or more different processing circuits processes the raw data for human consumption. A second one of the two or more different processing circuits processes the raw data for machine utilization such as for autonomous driving functions. Such an arrangement allows for greater flexibility in utilization of the data from the sensors without imposing undue latency in the processing stream and without compromising key performance indices for human use and machine use. In particular, different processing circuits may be differently optimized for such processing and may come from different vendors if desired. Still further, the processing circuits may have different levels of safety certifications depending on use. In a particularly contemplated aspect, the sensors are cameras, and the processing circuits are image processing circuits. While the data is provided to two such image processing circuits, the overall connection requirements may be reduced. Still further, by duplicating the data to the two different image processing circuits, the integrity of the data is not compromised by unnecessary encoding and decoding when transferred between two integrated circuits (ICs).

In this regard in one aspect, a vehicle is disclosed. The vehicle includes a sensor configured to sense data related to the vehicle and output raw data. The vehicle also includes a first ECU including a first processing circuit communicatively coupled to the sensor and configured to receive the raw data. The vehicle also includes a second ECU separate and distinct from the first ECU. The second ECU includes a second processing circuit communicatively coupled to the sensor and is configured to receive the raw data.

In another aspect, a vehicle is disclosed. The vehicle includes an image capturing sensor configured to sense image data related to the vehicle and output raw image data. The vehicle also includes a first ECU including a first image processing circuit communicatively coupled to the image capturing sensor and configured to receive the raw image data and output a visual representation of the raw image data on a display within the vehicle. The vehicle also includes a second ECU separate and distinct from the first ECU. The second ECU includes a second image processing circuit communicatively coupled to the image capturing sensor and is configured to receive the raw image data and process the raw image data for machine utilization.

In another aspect, a method is disclosed. The method includes capturing an image with a camera on a vehicle. The method also includes providing raw image data from the camera to a first image processing circuit in a first ECU. The method also includes providing the raw image data from the camera to a second image processing circuit in a second ECU separate and distinct from the first ECU. The method also includes presenting processed image data on a display within the vehicle after processing by the first image processing circuit.

In another aspect, an ECU for a vehicle is disclosed. The ECU includes a camera configured to capture images external to a vehicle. The ECU also includes a first output configured to provide raw image data from the camera to a first image processing circuit. The ECU also includes a second output configured to provide the raw image data from the camera to a second image processing circuit.

### BRIEF DESCRIPTION OF THE FIGURES

FIG. 1 is a simplified schematic diagram of an exemplary computing system within a vehicle;

FIG. 2 is a simplified top plan view of vision ranges for cameras on an exemplary vehicle;

FIG. 3 is an exemplary display output that provides informational advanced driver assistance system (ADAS) images for a vehicle operator;

FIG. 4 is a block diagram of an exemplary camera network where cameras broadcast raw image data to two image processing circuits through dedicated single serializers;

FIG. 5A is a block diagram of a second exemplary camera network where cameras provide raw image data to a first image processing circuit and a pass-through circuit passes the raw image data to a second image processing circuit;

FIG. 5B is a block diagram of an alternate pass-through circuit similar to FIG. 5A;

FIG. 6 is a block diagram of a third exemplary camera network where the cameras work with two serializers to provide raw image data to two image processing circuits; and

FIG. 7 is a flowchart illustrating an exemplary process for broadcasting raw image data to plural image processing circuits in a vehicle.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include methods and systems to broadcast sensor outputs in an automotive environment. In particular, sensors such as cameras output relatively unprocessed (raw) data to two or more different processing circuits where the processing circuits are located in separate and distinct embedded control units (ECUs). A first one of the two or more different processing circuits processes the raw data for human consumption. A second one of the two or more different processing circuits processes the raw data for machine utilization such as for autonomous driving functions. Such an arrangement allows for greater flexibility in utilization of the data from the sensors without imposing undue latency in the processing stream and without compromising key performance indices for human use and machine use. In particular, different processing circuits may be differently optimized for such processing and may come from different vendors if desired. Still further, the processing circuits may have different levels of safety certifications depending on use. In a particularly contemplated aspect, the sensors are cameras, and the processing circuits are image processing circuits. While the data is provided to two such image processing circuits, the overall connection requirements may be reduced. Still further, by duplicating the data to the two different image processing circuits, the integrity of the data is not compromised by unnecessary encoding and decoding when transferred between two integrated circuits (ICs).

While much of the present disclosure is presented in the context of cameras and image processing, the present disclosure is not so limited and the reader should appreciate that other sorts of image sensors such as radar, light detection and ranging (LIDAR), sonar, infrared, microwave, millimeter wave, 3d point cloud, and the like are also readily used in the systems and methods set forth herein. For example, raw radar data could be converted to b-scan and presented to an operator while concurrently the raw data could be used for machine vision perception and planning. Likewise, while image sensors and image processing are specifically contemplated, other sorts of sensors that may be used in multiple contexts may also benefit from the present disclosure. For example, data from a sensor that may be used to control an engine may also be presented for human perception. Other sensors that produce such operational control and informational data may also benefit from the present disclosure.

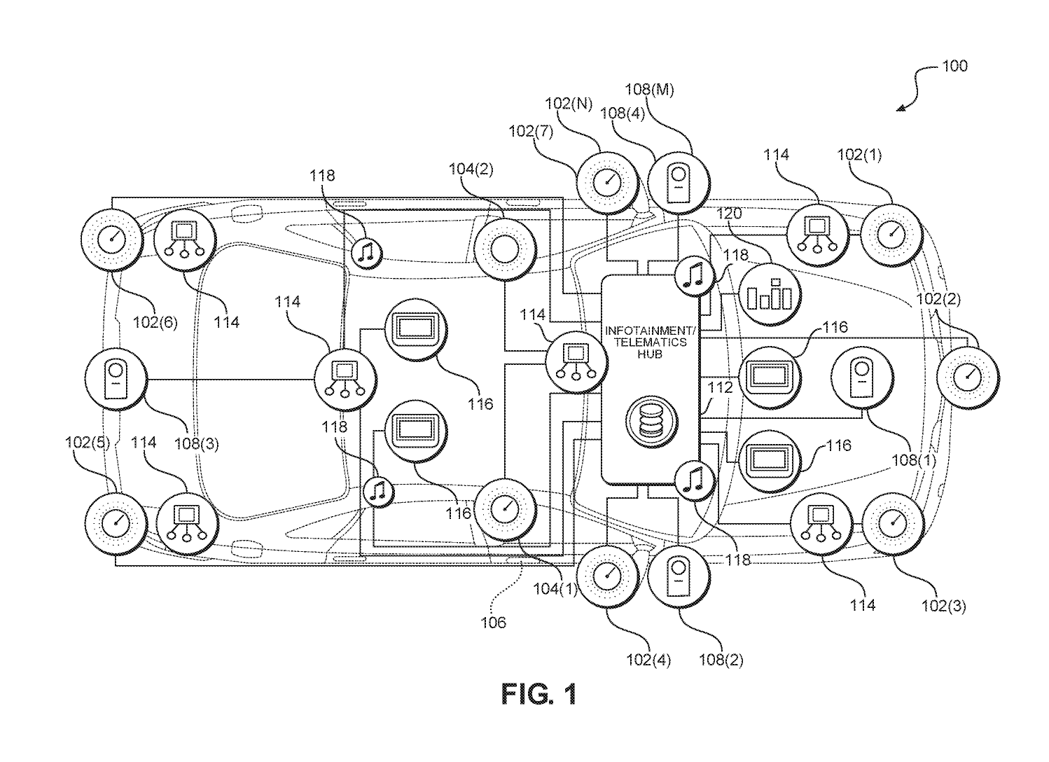

In this regard, FIG. 1 is a simplified block diagram of a vehicle 100. The vehicle 100 is illustrated as an automobile, but could be another form of vehicle such as a motorcycle, a boat, a plane, or the like. The vehicle 100 may include a variety of sensors 102(1)-102(N), where, as illustrated, N=7. It should be appreciated that more or fewer than seven sensors 102 may be present. The sensors 102(1)-102(N) may be proximity sensors that use sonar, lasers, or some form of radar to detect proximate objects. Additionally, the vehicle 100 may include one or more internal sensors 104(1)-104(2). The internal sensors 104(1)-104(2) may detect whether a door 106 is open or other internal condition of the vehicle 100. The vehicle 100 may further include one or more cameras 108(1)-108(M), where, as illustrated, M=4. It should be appreciated that more or fewer than four cameras 108 may be present. The vehicle 100 may have a network 110 that couples some or all of the sensors 102 and 104 to a hub 112. Network bridges 114 may be present to assist in providing the network 110. Displays 116 and speakers 118 may also be associated with the network 110. The hub 112 may include a control system that accesses software stored in memory 120. While aspects of the present disclosure contemplate that the cameras 108(1)-108(M) are directed externally (although they can be positioned externally or internally), it is possible that some or all of the cameras 108(1)-108(M) may be used to monitor the interior of the vehicle 100 (e.g., to see if the driver is awake or distracted).

The network 110 may be a single homogenous network such as a common bus having a multi-drop or ring topology, or may be formed from distinct communication links such as separate point-to-point cables.

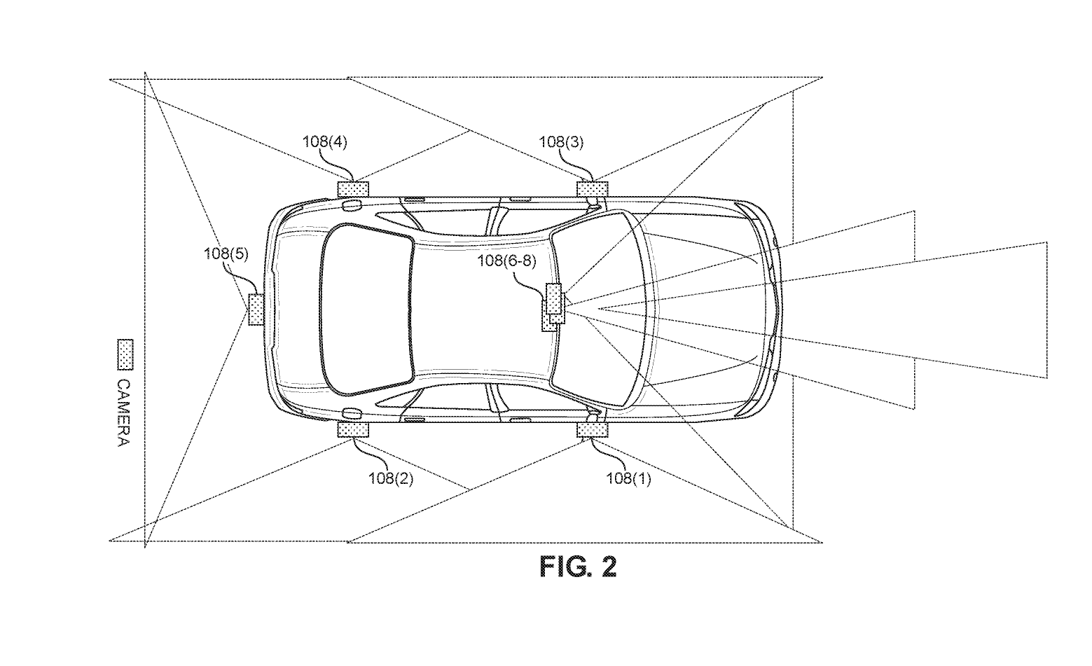

In practice, the cameras 108(1)-108(M) may provide a backup view to an operator on one of the displays 116 as well as provide data to a control system to assist in an advanced driver assistance system (ADAS). A camera sensor raw output may be converted to YUV for human consumption or gray scale for machine consumption. The camera sensor raw output (RGGB, RCCB, RCCC, RCCG) may even be fed directly to a deep neural network for object detection and tracking in an ADAS. FIG. 2 illustrates an exemplary set of fields of view for cameras 108(1)-108(8). As illustrated, the cameras 108(1)-108(4) are side cameras used for traffic, pedestrian, and signage detection and may be full frame fisheye high dynamic range (HDR) cameras. Camera 108(5) may be a rear-facing camera with a circular fisheye HDR camera. Cameras 108(6)-108(8) may be front facing and perform different functions. Camera 108(6) may be wide angle with a full frame fisheye lens for cut in, pedestrian, and traffic light detection. Camera 108(7) may be the main camera with a generally rectilinear lens to detect objects, lanes, and traffic lights as well as help with path delimiters and lateral control assistance. Camera 108(8) may be narrow rectilinear for object, lane, traffic light, and debris detection. The range of the camera 108(8) may be greater than the range of the camera 108(7).

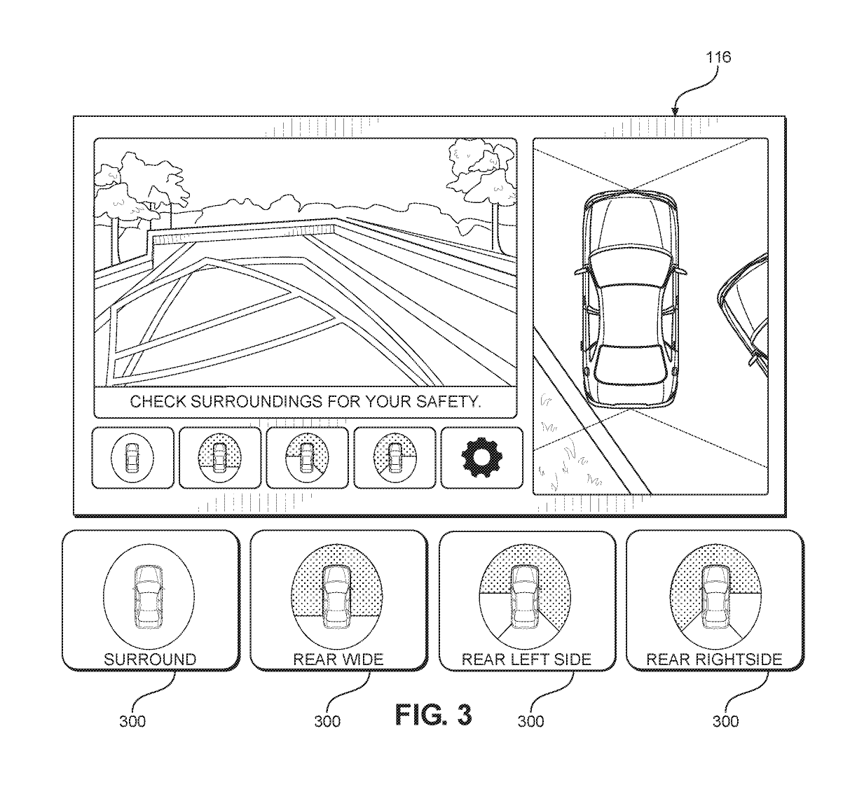

FIG. 3 illustrates an output from the camera 108(5) on one of the displays 116 while also allowing a user to select different views from different cameras through touch buttons 300.

In conventional systems, a single integrated circuit (IC) may operate as the control system. Such an approach imposes substantial burden on the IC requiring a relatively large circuit, which may have a large and/or costly silicon area with extensive packaging requirements. Such large silicon elements may have low yield due to the large die area. Likewise, such large multi-purpose circuits may result in independent processing functions competing for access to the associated shared memory, which may affect performance, reliability, and/or require additional links between the circuit and the memory. Other conventional systems may connect more than one IC together via a shared bus link, such as Peripheral Component Interconnect (PCI) express (PCIe), requiring careful thought and partitioning of processing tasks and transfer of data across the collection of ICs and the need to consider shared memory spaces and available bus communication data rates. Exemplary aspects of the present disclosure allow multiple distinct data processing circuits to interoperate with the sensors, reducing the need for such large multi-purpose circuits. The ability to use multiple data processing circuits allows the data processing circuits to be optimized for particular functions and separates different functions from competing for the same shared memory resource, which in turn may allow different safety certifications to be possible for different data processing circuits. Cost savings may be possible because the expense of certification testing may not be required for different ones of the circuits. As noted, in particularly contemplated aspects, the data processing circuits are image processing circuits, and the data is image data that may be processed differently depending on whether the image processing circuit is associated with machine consumption or human consumption.

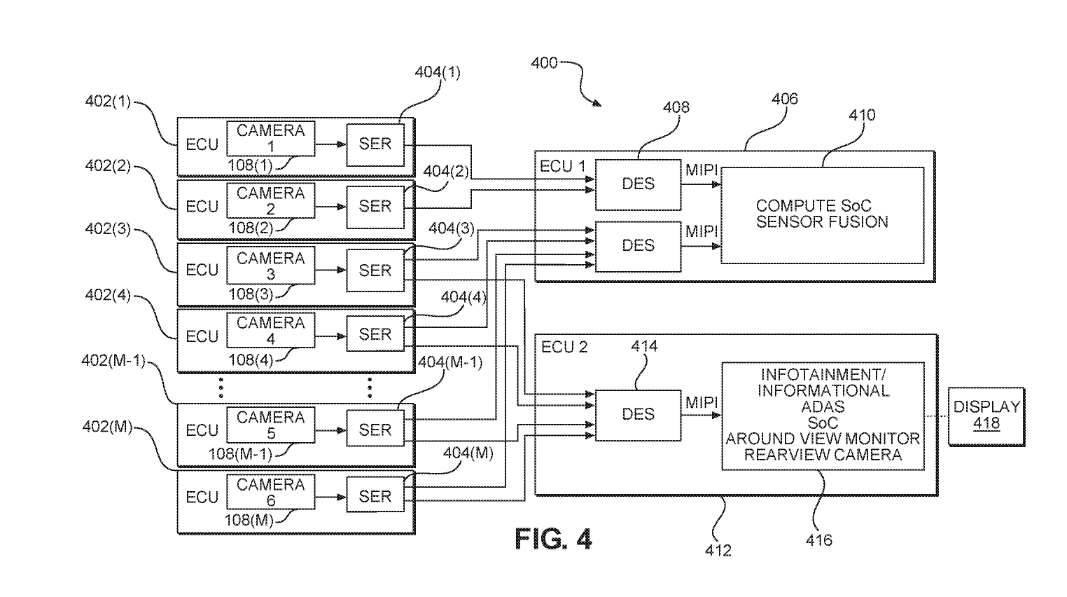

In this regard, exemplary aspects of the present disclosure allow for the cameras 108(1)-108(M) to broadcast raw image data to multiple image processing circuits. Four exemplary network structures are illustrated in FIGS. 4-6.

With reference to FIG. 4, a camera system 400 is illustrated wherein each camera 108(1)-108(M) is associated with an embedded control unit (ECU) 402(1)-402(M) that may have necessary and sufficient structure to house the associated camera 108(1)-108(M), local memory (not illustrated), an optional control system (not illustrated), and a network interface. The network interface may be a simple coaxial cable receptacle or the like. Additionally, each ECU 402(1)-402(M) includes a serializer/deserializer 404(1)-404(M). Some of the cameras 108(1)-108(M), e.g., cameras 108(1) and 108(2), may have no operator function and thus serializers/deserializers 404(1) and 404(2) may send their output to a computer vision ECU 406 and, in particular, to a deserializer/serializer 408 therein for processing by a computer vision system on a chip (SoC) 410. In contrast, some cameras (e.g., cameras 108(3)-108(M) may be useful for both operator assistance as well as ADAS functions. Serializers/deserializers 404(3)-404(M) may include dual-port outputs that provide raw image data not only to the computer vision ECU 406, but also to an infotainment ECU 412. It should be appreciated that the computer vision ECU 406 is separate and distinct from the infotainment ECU 412. A deserializer/serializer 414 receives and deserializes the data before passing the data to an infotainment SoC 416 having an associated display 418. Note that while referred to as an infotainment SoC, it should be appreciated that the SoC 416 may have only non-entertainment functions such as controlling a display for the backup camera to the operator. Such implementations are manufacturer specific and not central to the present disclosure. Of interest is the ability to broadcast the raw image data from the ECUs 402(1)-402(M) to both the image processing circuit that processes the raw image data for computer or machine use (i.e., the ADAS functions) and the image processing circuit that processes the raw image data for presentation to a human through a display. By bifurcating the processing functions, the image processing circuitry may be optimized for the respective function while taking input from a single shared camera sensor. Likewise, the image processing circuit for the ADAS functions may be automotive safety integrity level (ASIL) level D (ASIL-D) compliant (or ASIL-C or -B compliant as needed) while the image processing circuit for human consumption does not have to meet that rigorous standard. Further, this arrangement allows for relatively low latency as the data is not processed by one circuit and then passed to the other circuit for further processing. Still further, this arrangement avoids data corruption from encoding, decoding, and/or compression to get the data on a particular network format (e.g., an Ethernet vehicle network).

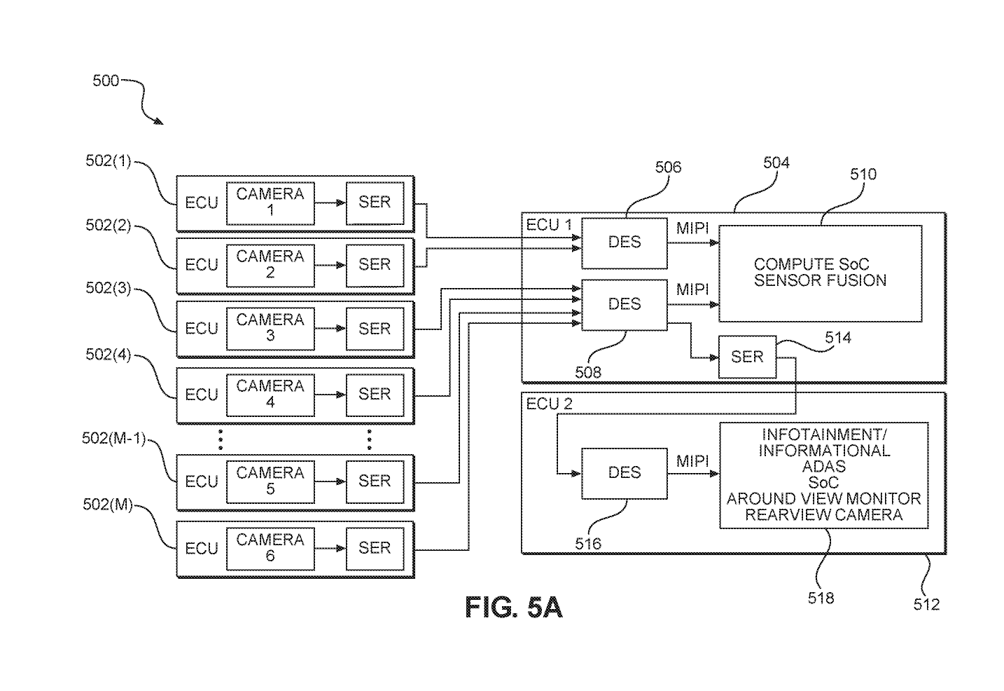

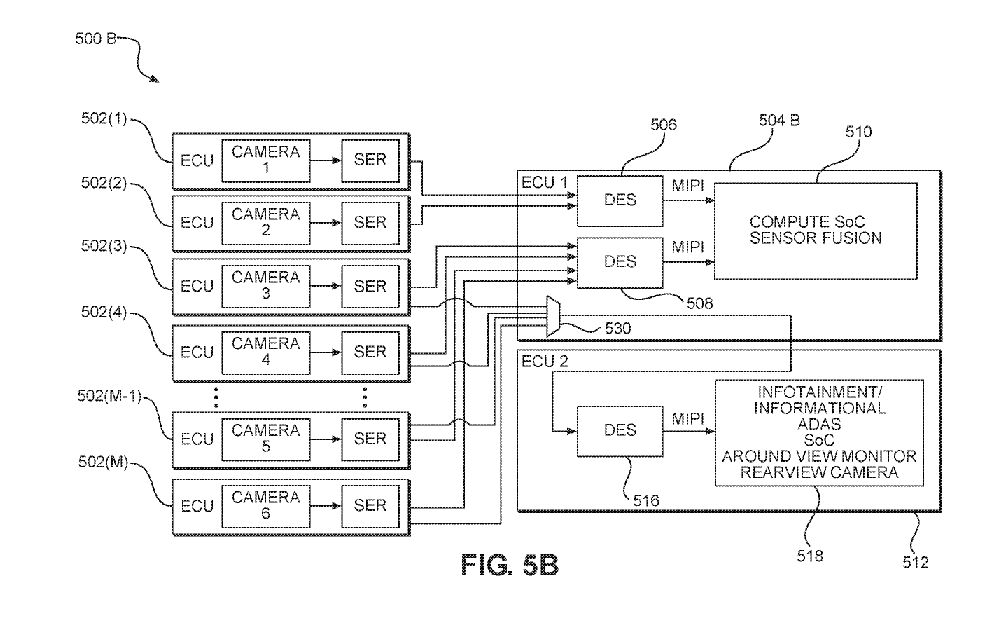

FIG. 5A provides an alternate camera system 500 where all ECUs 502(1)-502(M) provide raw data to a first ECU 504. The raw data is deserialized by deserializers/serializers 506 and 508. The data from the deserializer/serializer 506 is provided to a computer vision SoC 510. Data from the deserializer/serializer 508 is provided to both the computer vision SoC 510 and to a second ECU 512. In an exemplary aspect, the data is re-serialized by a serializer/deserializer 514 before being transmitted to the second ECU 512. Thus, the data is provided to the second ECU 512 by passing through the first ECU 504. In another exemplary aspect, the data is passed in parallel format to the second ECU 512. In still another aspect, the data is multiplexed before reaching the deserializer/serializer 508, and one path passes to the second ECU 512 without being deserialized at all until reaching the second ECU 512. At the second ECU 512, a deserializer/serializer 516 deserializes the data (if needed) and provides the data to an infotainment SoC 518. While the alternate camera system 500 has an extra connection between the first ECU 504 and the second ECU 512, this connection does not impose substantial latency delays. Most of the other advantages outlined above for the camera system 400 of FIG. 4 are also available for the alternate camera system 500. Note further, this arrangement allows for the infotainment SoC 518 to provide redundancy for the computer vision SoC 510 in the event of a failure therein.

A close variant of the alternate camera system 500 is alternate camera system 500B illustrated in FIG. 5B. The alternate camera system 500B also provides a pass-through arrangement. However, instead of deserializing and serializing inside a first ECU 504B, the first ECU 504B has a multiplexer 530 which takes the raw data from the ECUs 502(1)-502(M) and provides a single output to the second ECU 512, where the data is deserialized by the deserializer/serializer 516.

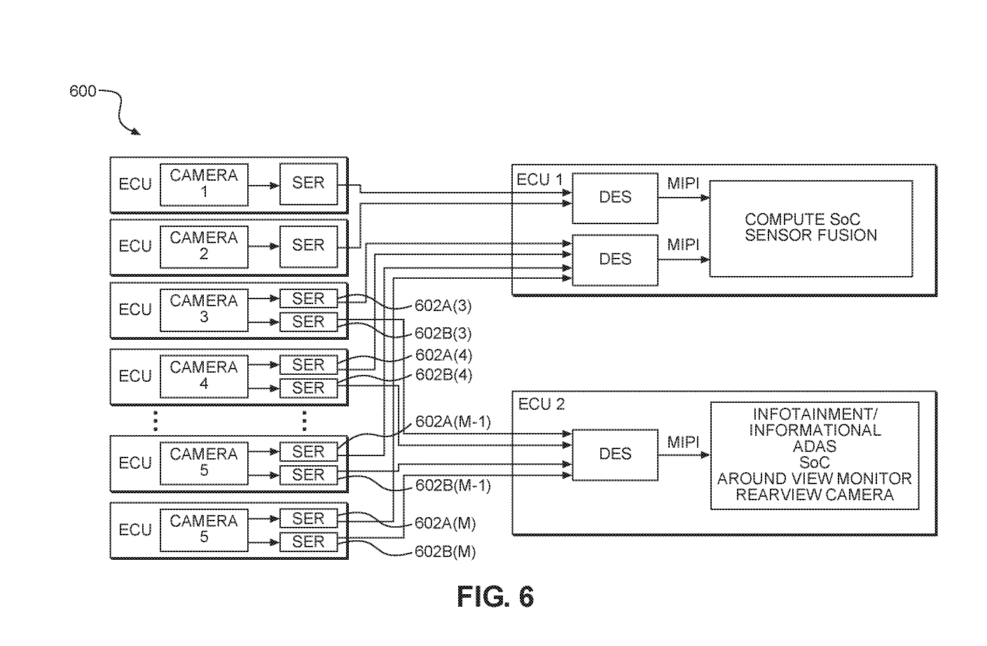

A fourth camera system 600 is illustrated in FIG. 6. In many respects the camera system 600 is similar to the camera system 400 of FIG. 4, but instead of a serializer/deserializer with two outputs, two serializers 602A(3)-602A(M) and 602B(3)-602B(M) are used.

It should be appreciated that while only two uses of sensor data are illustrated in FIGS. 4-6, the present disclosure is not so limited. The raw data may be provided to two or more different processing circuits. In an exemplary aspect, the raw data may be provided to a machine vision processing circuit, a human vision processing circuit, and a data logging circuit.

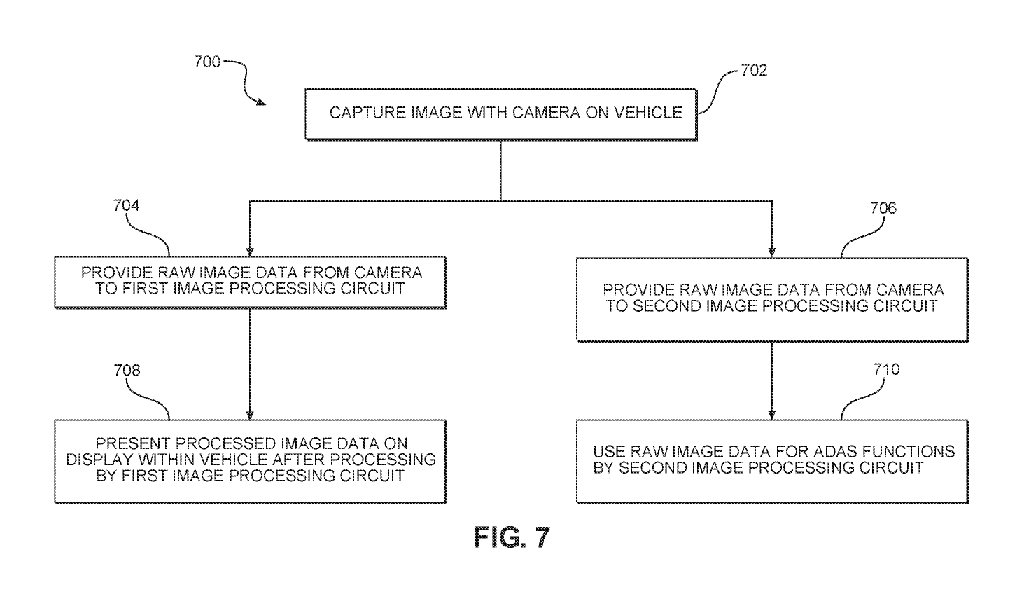

A flowchart of the method of operation is provided with reference to FIG. 7. The process 700 begins with capturing an image with a camera on a vehicle (block 702) and providing raw image data from the camera to a first image processing circuit (block 704). The raw image data is also provided from the camera to a second image processing circuit (block 706). The raw image data is then presented as processed image data on a display within the vehicle after processing by the first image processing circuit (block 708). Concurrently the raw image data is used for ADAS functions by the second image processing circuit (block 710).

As used herein raw image data includes, but is not limited to, Bayer RGB image data, RCCB, RCCC, RCCG, and monochrome.

While particularly contemplated as being appropriate for an automobile, it should be appreciated that the concepts disclosed herein are also applicable to other vehicles.

While not central to the present disclosure, it should be appreciated that in many instances there is a virtual backchannel or other backchannel present between ECUs. Thus, while the above discussion may focus on the serializer portion of the link from the camera to the deserializer portion of the link at the computer vision SoC end, the backchannel may allow data to pass from the SoC to the camera.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A vehicle comprising:
a sensor configured to sense data related to the vehicle and output raw data;
a first embedded control unit (ECU) comprising a first processing circuit communicatively coupled to the sensor and configured to receive the raw data; and
a second ECU separate and distinct from the first ECU, the second ECU comprising a second processing circuit communicatively coupled to the sensor and configured to receive the raw data.

2. The vehicle of claim 1, wherein the sensor comprises an image capturing sensor, the first processing circuit comprises a first image processing circuit, and the second processing circuit comprises a second image processing circuit.

3. The vehicle of claim 2, wherein the sensor comprises one of a radar sensor, a light detection and ranging (LIDAR) sensor, a sonar sensor, or a camera.

4. The vehicle of claim 2, further comprising an internal display coupled to the first image processing circuit and configured to present images from the sensor thereon after processing by the first image processing circuit.

5. The vehicle of claim 2, wherein the second image processing circuit is configured to process the raw data for an advanced driver assistance system (ADAS).

6. The vehicle of claim 2, wherein the sensor is positioned on the vehicle so as to sense data in front of the vehicle, to a side of the vehicle, or behind the vehicle.

7. The vehicle of claim 2, further comprising a serializer coupled to the sensor and to both the first image processing circuit and the second image processing circuit, wherein the serializer provides the raw data to the first image processing circuit and the second image processing circuit.

8. The vehicle of claim 2, further comprising a first serializer coupled to the sensor and configured to provide the raw data to the first image processing circuit and a second serializer coupled to the sensor and configured to provide the raw data to the second image processing circuit.

9. The vehicle of claim 2, further comprising:
a first serializer coupled to the sensor and the first image processing circuit; and
a pass-through circuit configured to receive the raw data from the first serializer and provide the raw data to the second image processing circuit.

10. The vehicle of claim 9, wherein the first ECU further comprises:
a first deserializer configured to receive the raw data from the first serializer; and
a second serializer configured to receive the raw data from the first deserializer and send the raw data to the second ECU.

11. The vehicle of claim 1, wherein the raw data comprises Bayer RGB data.

12. The vehicle of claim 1, wherein the sensor comprises a high dynamic range (HDR) camera.

13. The vehicle of claim 1, further comprising a third ECU separate and distinct from the first ECU, the third ECU comprising a third processing circuit communicatively coupled to the sensor and configured to receive the raw data.

14. The vehicle of claim 1, wherein the second processing circuit is up to automotive safety integrity level (ASIL) level D (ASIL-D) compliant.

15. The vehicle of claim 1, wherein the sensor is configured to detect a condition within the vehicle.

16. A vehicle comprising:
an image capturing sensor configured to sense image data related to the vehicle and output raw image data;
a first embedded control unit (ECU) comprising a first image processing circuit communicatively coupled to the image capturing sensor and configured to receive the raw image data and output a visual representation of the raw image data on a display within the vehicle; and
a second ECU separate and distinct from the first ECU, the second ECU comprising a second image processing circuit communicatively coupled to the image capturing sensor and configured to receive the raw image data and process the raw image data for machine utilization.

17. The vehicle of claim 16, wherein the machine utilization comprises an advanced driver assistance system (ADAS).

18. A method comprising:
capturing an image with a camera on a vehicle;
providing raw image data from the camera to a first image processing circuit in a first embedded control unit (ECU);
providing the raw image data from the camera to a second image processing circuit in a second ECU separate and distinct from the first ECU; and
presenting processed image data on a display within the vehicle after processing by the first image processing circuit.

19. The method of claim 18, further comprising using the raw image data from the camera for machine vision purposes through the second image processing circuit.

20. The method of claim 19, wherein using the raw image data for machine vision purposes comprises using the raw image data for an advanced driver assistance system (ADAS).

21. An embedded control unit (ECU) for a vehicle, the ECU comprising:
a camera configured to capture images external to a vehicle;
a first output configured to provide raw image data from the camera to a first image processing circuit; and
a second output configured to provide the raw image data from the camera to a second image processing circuit.

22. The ECU of claim 21, further comprising a serializer that includes the first output and the second output.

23. The ECU of claim 21, further comprising a first serializer that includes the first output and a second serializer that includes the second output.
